(19) United States
(12) Patent Application Publication
(10) Pub. No.: US 2026/0119535 A1
(43) Pub. Date: Apr. 30, 2026

(54) INFORMATION PROCESSING SYSTEM AND INFORMATION PROCESSING METHOD

(71) Applicant: Semiconductor Energy Laboratory Co., Ltd., Atsugi-shi (JP)

(72) Inventors: Junpei MOMO, Sagamihara (JP); Kazuki HIGASHI, Atsugi (JP)

(21) Appl. No.: 19/352,529

(22) Filed: Oct. 8, 2025

(30) Foreign Application Priority Data
Oct. 30, 2024 (JP) 2024-190541

(51) Int. Cl. G06F 16/332; G06F 16/3329

(52) U.S. Cl. CPC G06F 16/3322; G06F 16/33295

(57) ABSTRACT

A novel information processing system that is composed of three components is provided. A first component has a function of receiving information and providing a suggestion. A second component has a function of generating an evaluation result using a large language model and transmitting the evaluation result to a third component. The third component has a function of receiving the information, receiving the evaluation result, and providing the suggestion. The third component includes subcomponents, and a first subcomponent performs processing using a database and a management system. A second subcomponent creates a query and a group of prompts. A third subcomponent has a function of creating the suggestion. In this system, processing related to a synthesis route information or conditions of a substance can be performed by receiving the information, generating the evaluation result, and providing the suggestion.

### BACKGROUND OF THE INVENTION

### 1. Field of the Invention

One embodiment of the present invention relates to an information processing system, an information processing method, or a semiconductor device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Thus, more specifically, examples of the technical field of one embodiment of the present invention disclosed in this specification include an information processing device, a semiconductor device, a memory device, a method for driving any of them, and a method for manufacturing any of them.

### 2. Description of the Related Art

In recent years, language models using neural networks have been actively developed, and especially large language models (LLM) have attracted attention. An LLM is a natural language processing model learned using a large amount of data. With an LLM, for example, an interactive model that gives an answer to a user's instruction can be achieved. In Non-Patent Document 1, generative pre-trained transformer 4 (GPT-4, registered trademark) is disclosed as an LLM, and ChatGPT is disclosed as an interactive model.

By utilizing an LLM, the capability of a natural language processing model has been significantly increased. On the other hand, owing to the expansion of the language model, it is difficult to incorporate and operate a language model on one's own from the aspect of facilities and costs. Accordingly, a language model provided by an external service is generally used.

In addition, a database constructed by reactions reported in chemical literatures since 1779 is known (Non-Patent Document 2).

### References

### Non-Patent Documents

Non-Patent Document 1 Summary of ChatGPT/GPT-4 Research and Perspective Towards the Future of Large Language Models, Yiheng Liu et al., (submitted on 4 Apr, 2023) [online], Internet URL: https://arxiv.org/abs/2304.01852

Non-Patent Document 2 Bartosz A. Grzybowski, Angew. Chem. Int. Ed. 2012, 51, 7922 -7927

### SUMMARY OF THE INVENTION

An object of one embodiment of the present invention is to provide a novel information processing system that is highly convenient, useful, or reliable. Another object is to provide a novel information processing method that is highly convenient, useful, or reliable. Another object is to provide a novel information processing system, a novel information processing method, or a novel semiconductor device.

Note that the description of these objects does not preclude the existence of other objects. One embodiment of the present invention does not need to achieve all of these objects. Other objects will be apparent from and can be derived from the description of the specification, the drawings, the claims, and the like.

(1) One embodiment of the present invention includes a first component, a second component, and a third component.

The first component has a function of receiving first information and transmitting the first information to the third component and a function of receiving a suggestion and providing the suggestion. Note that the first information includes a condition and information specifying a substance.

The second component has a function of receiving a first prompt, transmitting an evaluation result to the third component, and performing processing using a large language model. The large language model has a function of generating the evaluation result in accordance with the first prompt.

The third component has a function of receiving the first information and sharing the first information in the third component, a function of transmitting the first prompt to the second component, and a function of receiving the evaluation result and transmitting the suggestion to the first component. The third component includes a first subcomponent, a second subcomponent, a third subcomponent.

The first subcomponent has a function of performing processing using a database and a management system. Note that the management system has a function of creating a first list from the database on the basis of a first query, and the first list includes information on a synthesis route information of the substance.

The second subcomponent has a function of creating the first query and a group of prompts. Note that the first query includes a query for a synthesis route and a synthesis condition of the substance. The group of prompts includes the first prompt, and the first prompt includes a first instruction, a piece of the synthesis route information selected from the first list, and the first information. The first instruction includes an instruction to evaluate the synthesis route information on the basis of the condition to generate the evaluation result.

The third subcomponent has a function of creating the suggestion. Note that the suggestion includes the synthesis route information and the evaluation result.

(2) Another embodiment of the present invention is the above information processing system in which the database is a graph database.

The graph database includes a first node, a second node, and an edge. The edge connects the first node and the second node, and the edge includes a condition for moving from the second node to the first node.

The synthesis route information includes the first node and an edge list, the first node is assigned to a substance, and the edge is assigned to the generation reaction of the substance. The edge list includes the edge.

(3) Another embodiment of the present invention is the above information processing system in which the synthesis route information includes three or more nodes.

(4) Another embodiment of the present invention is the above information processing system in which the database includes the network of organic chemistry.

Thus, the synthesis route of the substance can be searched using the database. The one or more synthesis routes can be searched using the database. In addition, a difference between the condition and the synthesis conditions obtained from the database can be found. As a result, a novel information processing system that is highly convenient, useful, or reliable can be provided.

(5) Another embodiment of the present invention is the above information processing system in which the evaluation result includes an evaluation score. Note that the evaluation score increases as a difference between the condition and the synthesis route information becomes small. The suggestion includes the evaluation results in descending order of evaluation scores.

Thus, the synthesis route of the substance can be searched using the database. The one or more synthesis routes can be searched using the database. In addition, a difference between the condition and the synthesis conditions obtained from the database can be found. Furthermore, the suggestion can be provided in ascending order of the difference between the condition and the synthesis conditions obtained from the database. As a result, a novel information processing system that is highly convenient, useful, or reliable can be provided.

(6) Another embodiment of the present invention is the above information processing system in which the first component has a function of receiving the synthesis route information and transmitting the synthesis route information to the third component and a function of receiving a procedure manual and providing the procedure manual.

The synthesis route information is selected from the suggestion, and the synthesis route information includes the edge list. The edge list includes the edge, and the edge includes information specifying a document.

The second component has a function of receiving a second prompt, transmitting the procedure manual the third component, and performing processing using a large language model. The large language model has a function of generating the procedure manual in accordance with the second prompt.

The third component has a function of receiving the synthesis route information and sharing the synthesis route information in the third component, a function of transmitting the second prompt to the second component, and a function of receiving the procedure manual and transmitting the procedure manual to the first component.

The first subcomponent has a function of creating a second list from the graph database using the management system on the basis of a second query. Note that the second list stores the document.

The second subcomponent has a function of creating the second query and the second prompt. Note that the second query includes a query to collect the document specified in the edge list into the second list. The second prompt includes a second instruction and the second list, and the second instruction includes an instruction to generate the procedure manual from the second list.

Thus, for example, the user of the information processing system can select the synthesis route information from the suggestion. The information processing system of one embodiment of the present invention can collect the document related to the selected synthesis route information from the graph database. The information processing system of one embodiment of the present invention can generate and provide the procedure manual from the document related to the synthesis route information. As a result, a novel information processing system that is highly convenient, useful, or reliable can be provided.

(7) One embodiment of the present invention is an information processing method including a first phase, and the first phase includes a first step, a second step, a third step, a fourth step, a fifth step, a sixth step, a seventh step, an eighth step, a ninth step, and a tenth step.

In the first step of the first phase, a first component receives a first information and transmits the first information to a second component. Note that the first information includes a condition and information specifying a substance.

In the second step of the first phase, the second component receives the first information and shares the first information in the second component.

The second component includes a first subcomponent, a second subcomponent, and a third subcomponent. The first subcomponent has a function of performing processing using a database and a management system.

In the third step of the first phase, the second subcomponent creates a first query and shares the first query in the second component. Note that the first query includes a query related to a synthesis route and a synthesis condition of the substance.

In the fourth step of the first phase, the first subcomponent creates a first list from the database using the management system on the basis of the first query and shares the first list in the second component. Note that the first list includes information on a synthesis route information of the substance.

In the fifth step of the first phase, the second subcomponent creates a group of prompts and transmits a first prompt to a third component. Note that the group of prompts includes the first prompt, and the first prompt includes a first instruction, a piece of the synthesis route information selected from the first lists, and a first information. The first instruction includes an instruction to evaluate the synthesis route information on the basis of condition and generate an evaluation result.

In the sixth step of the first phase, the third component receives the first prompt and generates the evaluation result with use of a large language model.

In the seventh step of the first phase, the third component transmits the evaluation result to the second component.

In the eighth step of the first phase, the second component receives the evaluation result and shares the evaluation result in the second component.

In the ninth step of the first phase, the third subcomponent creates a suggestion and transmits the suggestion to the first component. Note that the suggestion includes the synthesis route information and the evaluation result.

In the tenth step of the first phase, the first component receives the suggestion and provides the suggestion.

Thus, the synthesis route of the substance can be searched using the database. The one or more synthesis routes can be searched using the database. In addition, a difference between the condition and the synthesis conditions obtained from the database can be found. As a result, a novel information processing method that is highly convenient, useful, or reliable can be provided.

(8) Another embodiment of the present invention is an information processing method including the first phase and a second phase.

The second phase follows the first phase, and includes a first step, a second step, a third step, a fourth step, a fifth step, a sixth step, a seventh step, an eighth step, and a ninth step.

In the first step of the second phase, the first component receives the synthesis route information and transmits the synthesis route information to the second component.

In the second step of the second phase, the second component receives the synthesis route information and shares the synthesis route information in the second component.

In the third step of the second phase, the second subcomponent creates a second query and shares the second query in the second component.

Note that the second query includes a query to collect a document specified in an edge list into a second list. The edge list includes an edge, the edge includes information specifying the document, and the second list stores the document.

In the fourth step of the second phase, the first subcomponent creates the second list from the database using the management system on the basis of the second query, and the first subcomponent shares the second list in the second component.

In the fifth step of the second phase, the second subcomponent creates a second prompt and transmits the second prompt to the third component. Note that the second prompt includes a second instruction and the second list, and the second instruction includes an instruction to generate a procedure manual from the second list.

In the sixth step of the second phase, the third component receives the second prompt and generates the procedure manual with use of the large language model.

In the seventh step of the second phase, the third component transmits the procedure manual to the second component.

In the eighth step of the second phase, the second component receives the procedure manual and transmits the procedure manual to the first component.

In the ninth step of the second phase, the first component receives the procedure manual and provides the procedure manual.

Thus, for example, the user of the information processing system can select the synthesis route information from the suggestion. The information processing system of one embodiment of the present invention can collect the document related to the selected synthesis route information from the edge list. The information processing system of one embodiment of the present invention can generate and provide the procedure manual from the document related to the synthesis route information. As a result, a novel information processing method that is highly convenient, useful, or reliable can be provided.

One embodiment of the present invention can provide a novel information processing system that is highly convenient, useful, or reliable. Alternatively, a novel information processing method that is highly convenient, useful, or reliable can be provided. Alternatively, a novel information processing system, a novel information processing method, or a novel semiconductor device can be provided.

Note that the description of these effects does not preclude the presence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

FIG. 1 illustrates a structure of an information processing system of an embodiment.

FIG. 2 illustrates a structure of a component used in an information processing system of an embodiment.

FIGS. 3A and 3B illustrate structures of information used in an information processing system of an embodiment.

FIGS. 4A and 4B illustrate structures of information used in an information processing system of an embodiment.

FIGS. 5A and 5B illustrate structures of information used in an information processing system of an embodiment.

FIGS. 6A and 6B illustrate structures of information used in an information processing system of an embodiment.

FIG. 7 illustrates a structure of an information processing system of an embodiment.

FIG. 8 illustrates a structure of a component used in an information processing system of an embodiment.

FIGS. 9A and 9B illustrate structures of information used in an information processing system of an embodiment.

FIGS. 10A and 10B illustrate structures of information used in an information processing system of an embodiment.

FIG. 11 illustrates a structure of an information processing device used for an information processing system of an embodiment.

FIG. 12 illustrates an information processing method of an embodiment.

FIG. 13 illustrates an information processing method of an embodiment.

FIG. 14 illustrates an information processing method of an embodiment.

FIG. 15 illustrates an information processing method of an embodiment.

### DETAILED DESCRIPTION OF THE INVENTION

An information processing system of one embodiment of the present invention includes a first component, a second component, and a third component. The first component has a function of receiving information and transmitting the information to the third component and a function of receiving a suggestion and providing the suggestion. Note that the information includes a condition and information specifying a substance. The second component has a function of receiving a first prompt, transmitting an evaluation result to the third component, and performing processing using a large language model. The large language model has a function of generating the evaluation result in accordance with the first prompt.

The third component has a function of receiving the information and sharing the information in the third component, a function of transmitting the first prompt to the second component, and a function of receiving the evaluation result and transmitting the suggestion to the first component. The third component includes a first subcomponent, a second subcomponent, a third subcomponent.

The first subcomponent has a function of performing processing using the database and the management system, and the management system has a function of creating a first list from the database on the basis of a first query. Note that the first list includes information on synthesis route information of a substance.

The second subcomponent has a function of creating the first query and a group of prompts. Note that the first query includes a query related to a synthesis route and a synthesis condition of a substance, the group of prompts include the first prompt, and the first prompt includes a first instruction, one of the synthesis route information selected from the first list, and information. The first instruction includes an instruction to evaluate the synthesis route information on the basis of condition to generate the evaluation result.

The third subcomponent has a function of creating suggestion which includes the synthesis route information and the evaluation result.

Thus, the synthesis route of the substance can be searched using the database. The one or more synthesis routes can be searched using the database. In addition, a difference between the condition and the synthesis conditions obtained from the database can be found. As a result, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as "first" and "second" in this specification and the like are used in order to avoid confusion among components. Thus, the terms do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

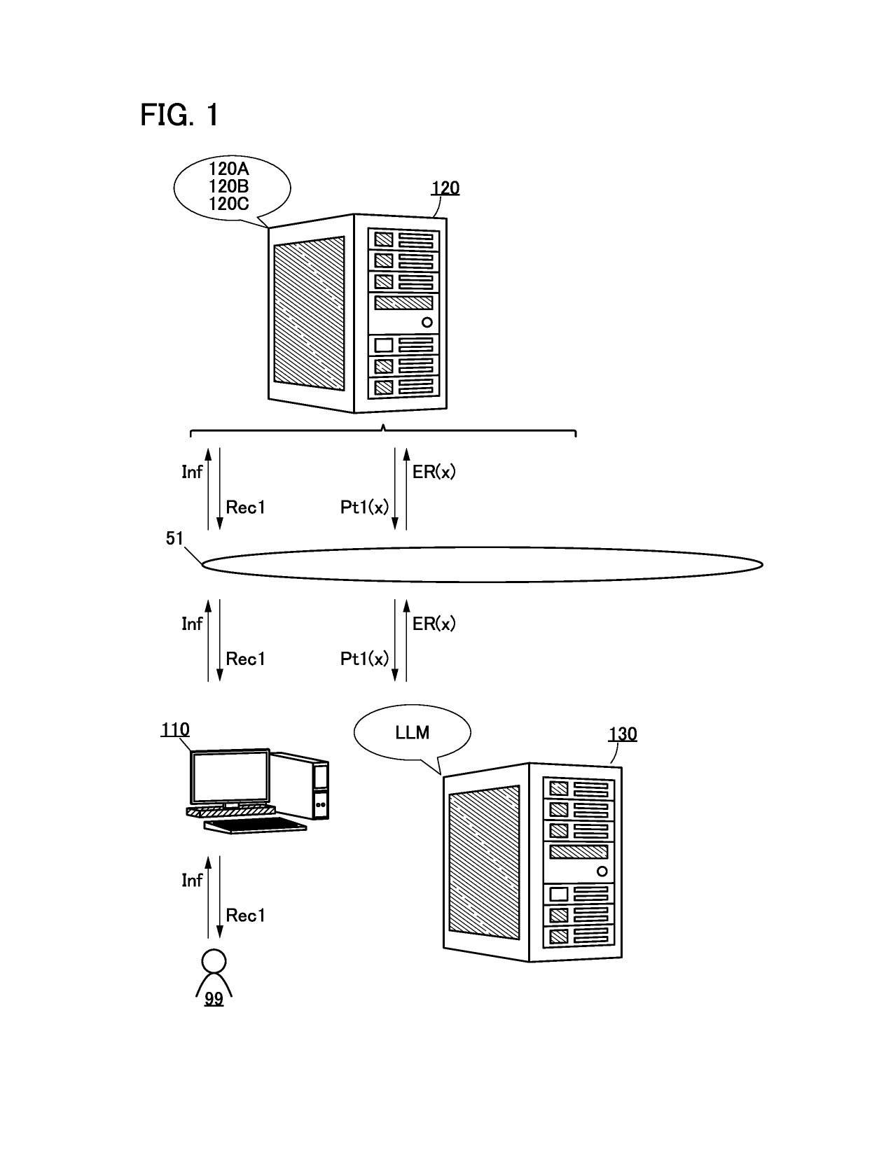

In this embodiment, an information processing system of one embodiment of the present invention will be described with reference to FIG. 1 to FIG. 11.

FIG. 1 illustrates a structure of an information processing system of one embodiment of the present invention.

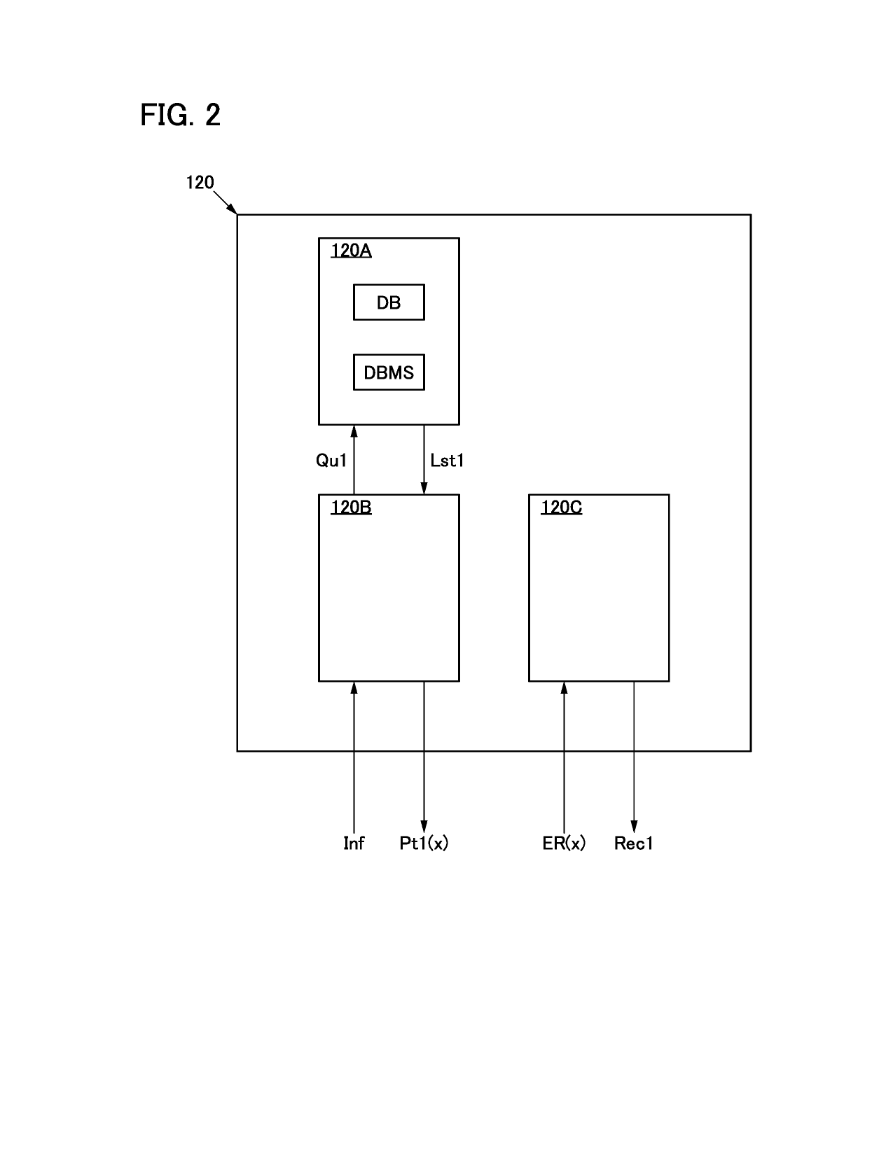

FIG. 2 illustrates a structure of a component used in the information processing system of one embodiment of the present invention.

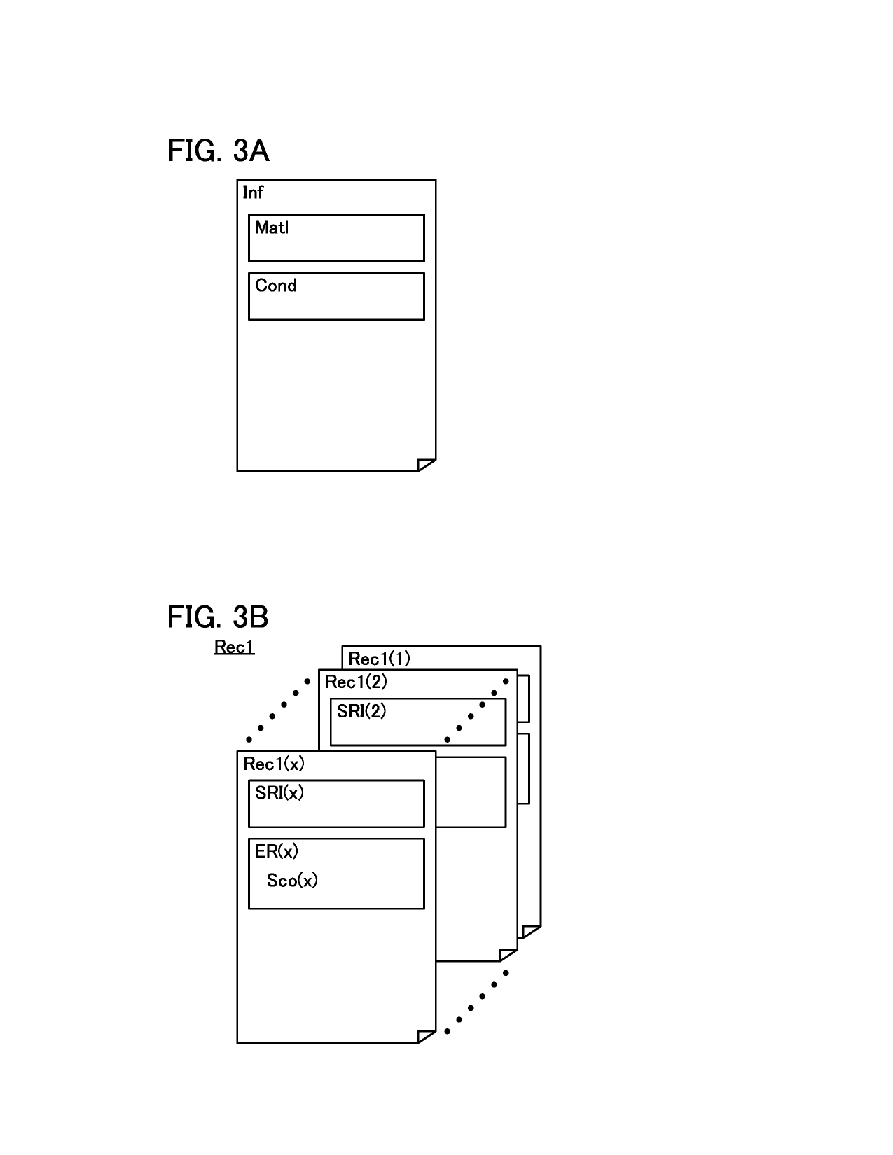

FIG. 3A illustrates a structure of information transmitted and received inside the information processing system of one embodiment of the present invention, and FIG. 3B illustrates a structure of a suggestion.

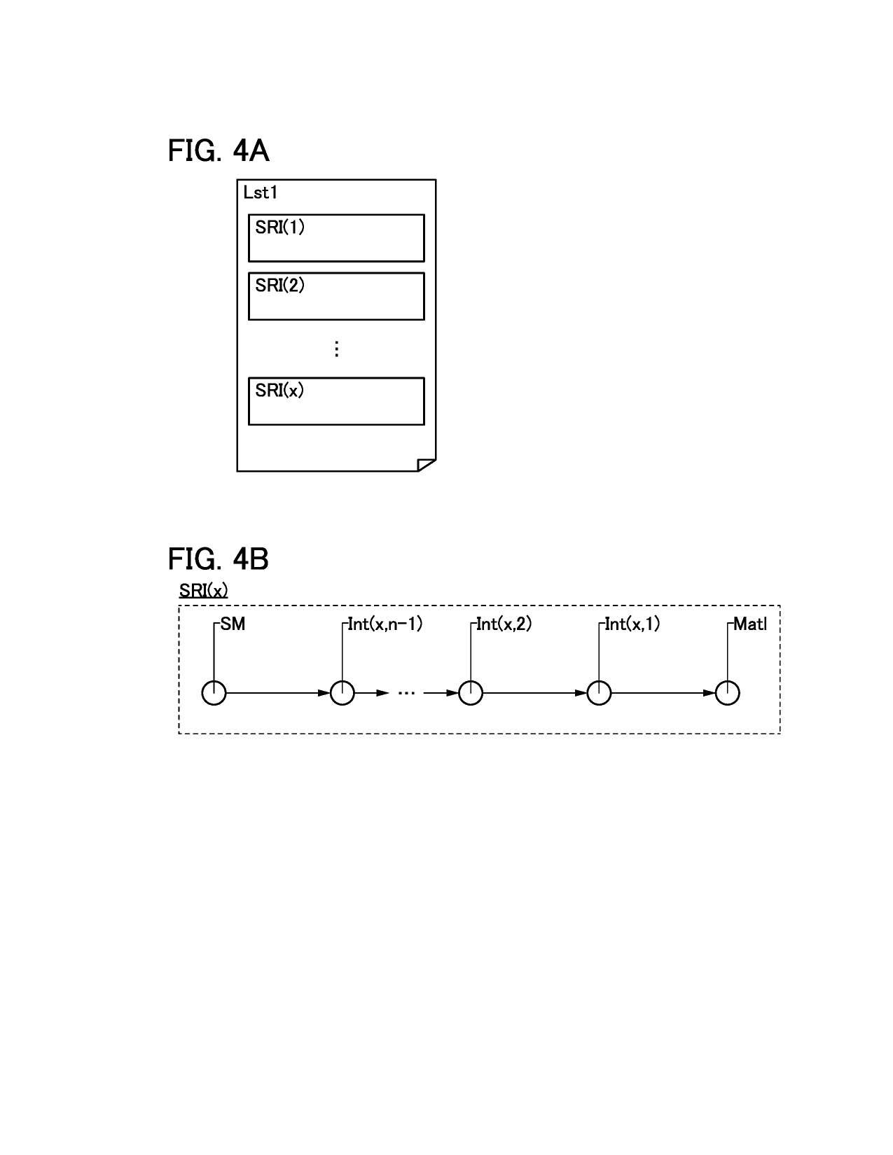

FIG. 4A illustrates a structure of a list transmitted and received inside the information processing system of one embodiment of the present invention, and FIG. 4B illustrates a structure of synthesis route information.

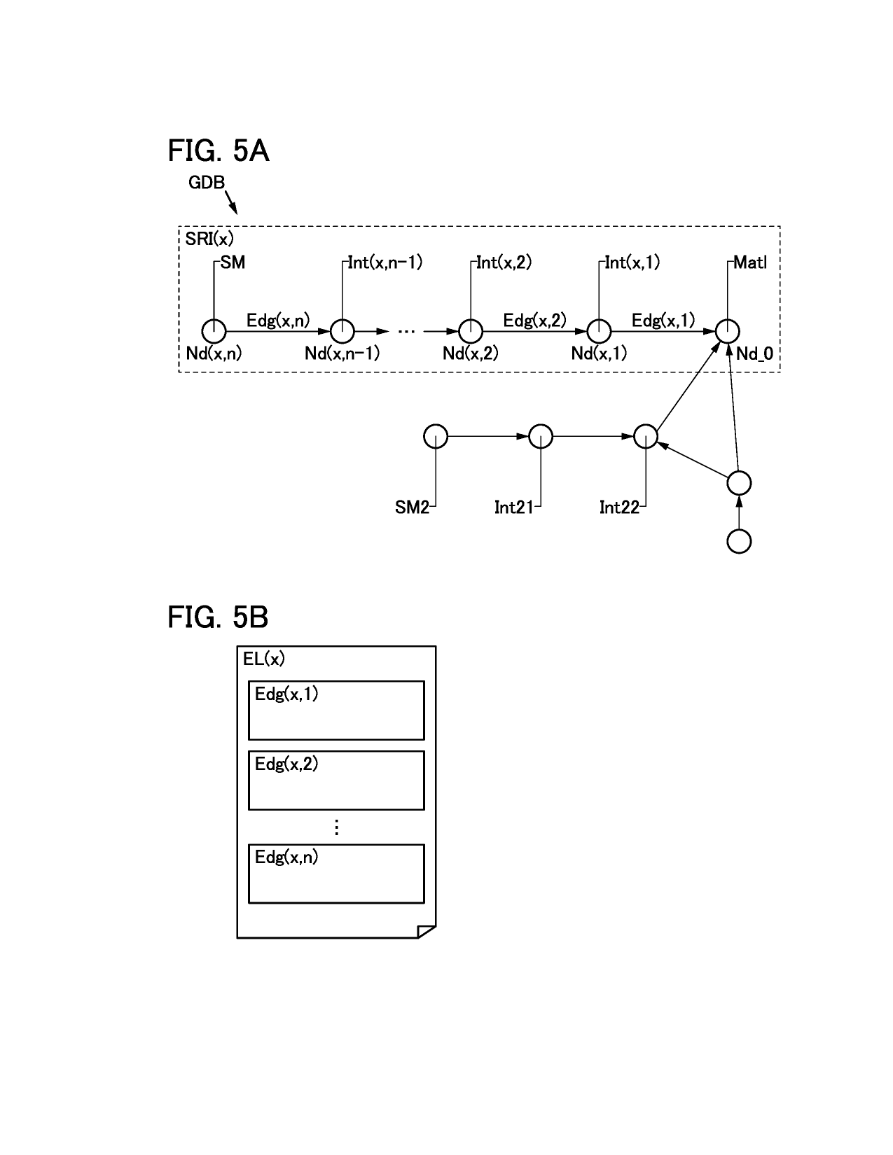

FIG. 5A illustrates a structure of a database that can be used for the information processing system of one embodiment of the present invention, and FIG. 5B illustrates a structure of an edge list.

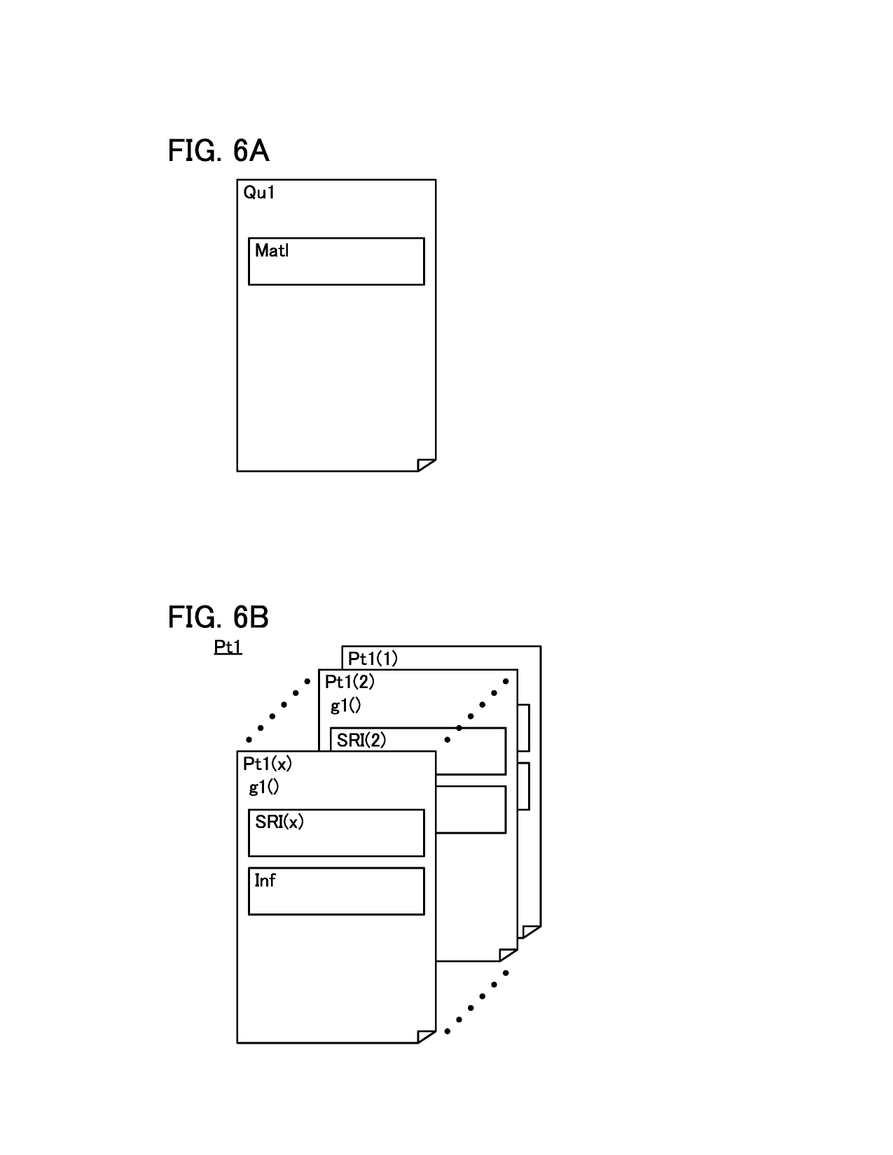

FIG. 6A illustrates a structure of a query transmitted and received inside the information processing system of one embodiment of the present invention, and FIG. 6B illustrates a structure of a group of prompts.

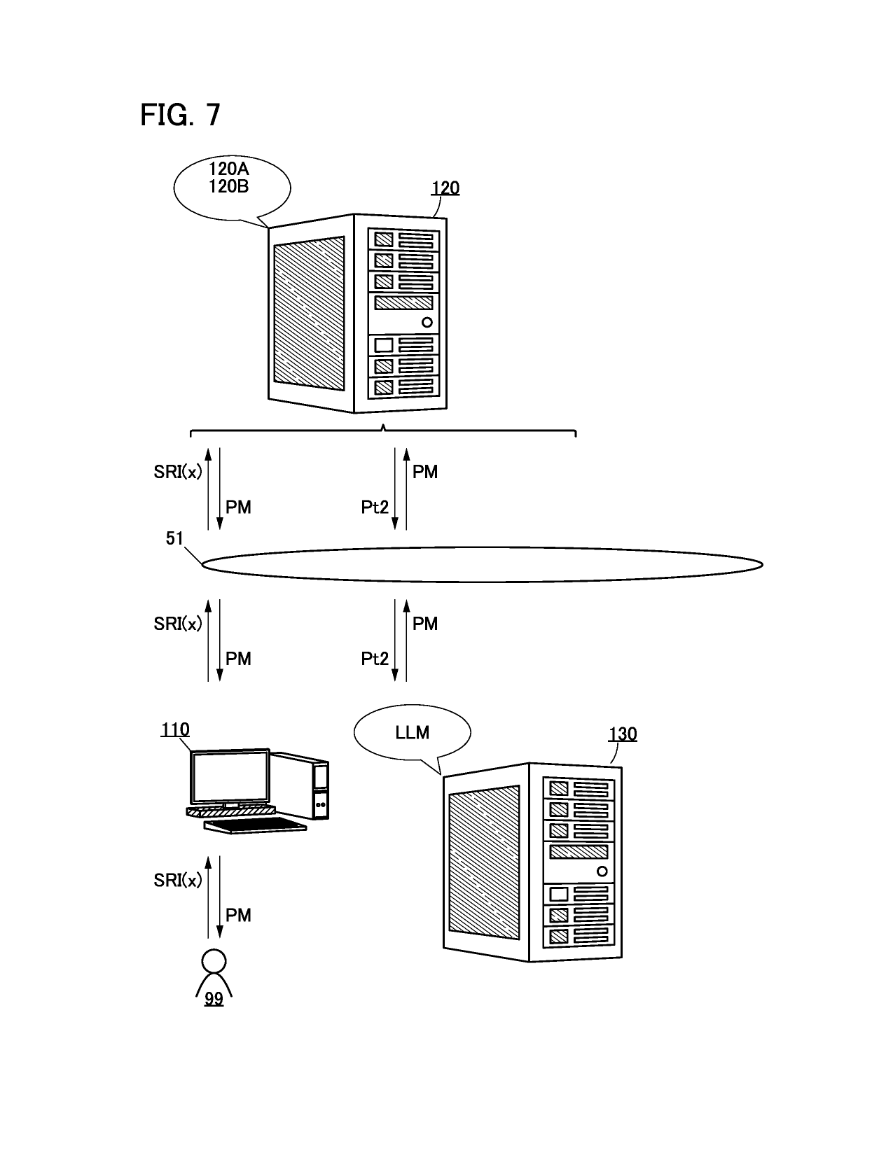

FIG. 7 is a diagram illustrating a structure of the information processing system of one embodiment of the present invention.

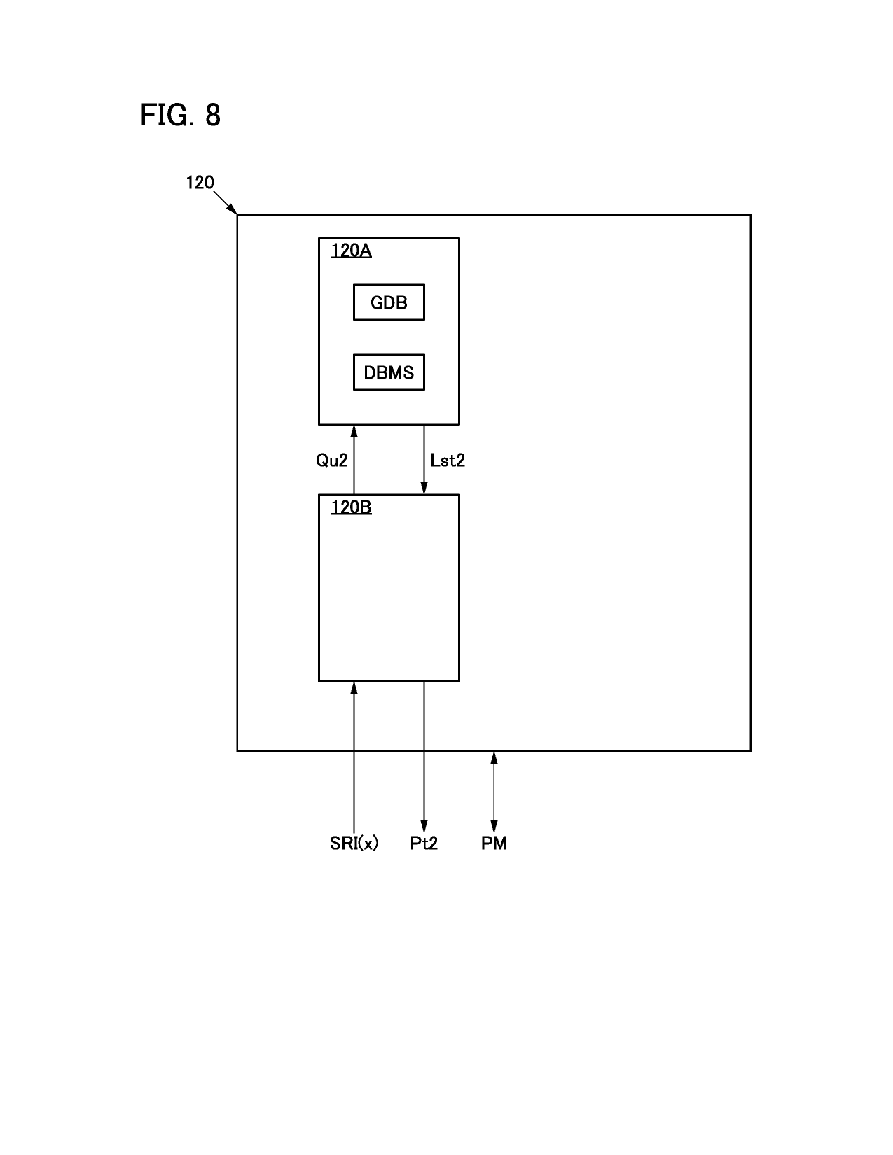

FIG. 8 illustrates a structure of a component used in the information processing system of one embodiment of the present invention.

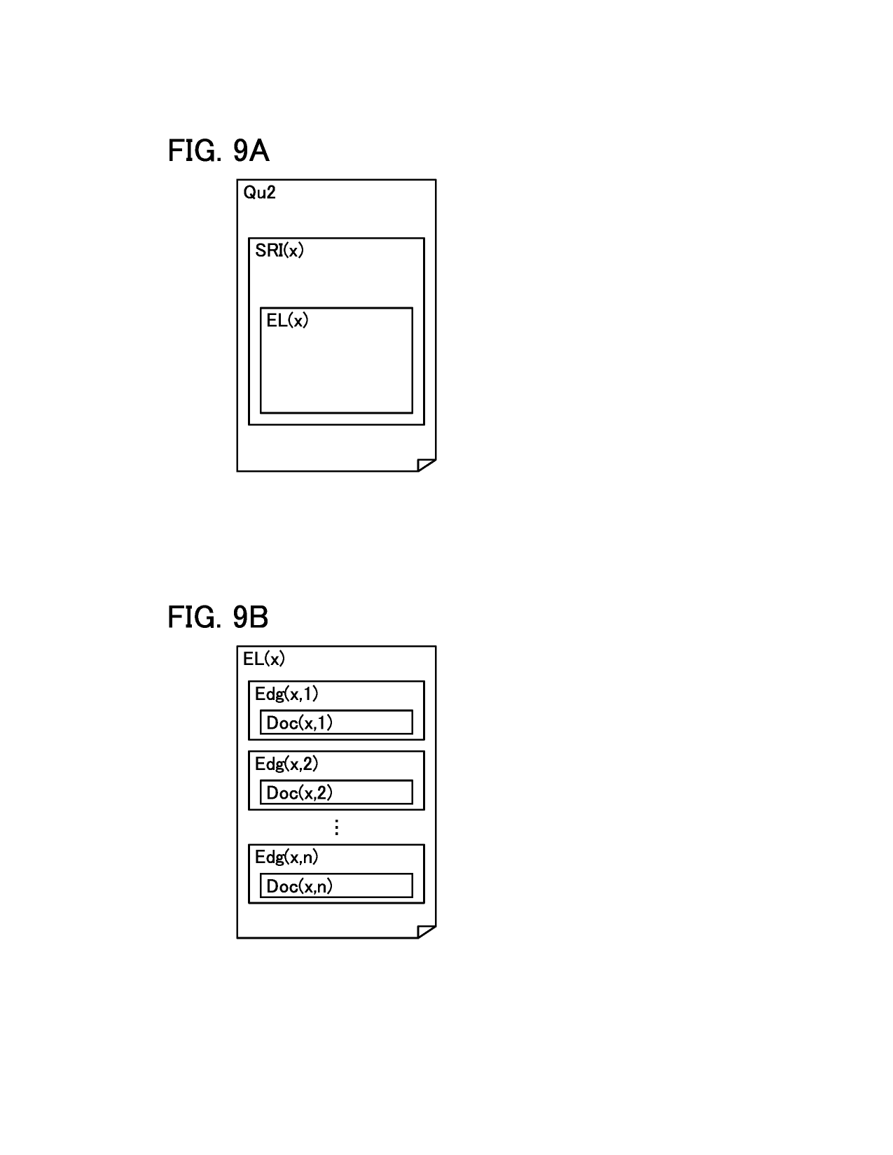

FIG. 9A illustrates a structure of a query transmitted and received inside the information processing system of one embodiment of the present invention, and FIG. 9B illustrates a structure of an edge list.

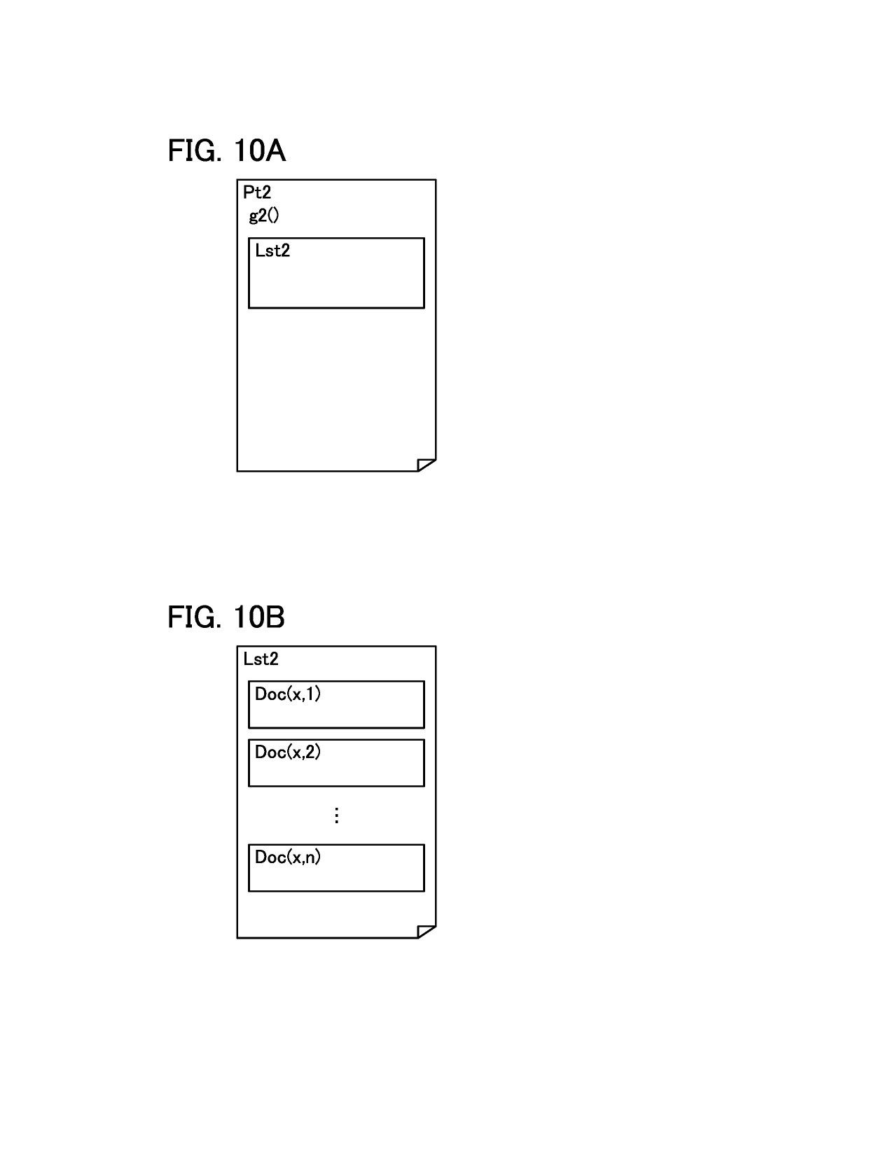

FIG. 10A illustrates a structure of a prompt transmitted and received inside the information processing system of one embodiment of the present invention, and FIG. 10B illustrates a structure of a list.

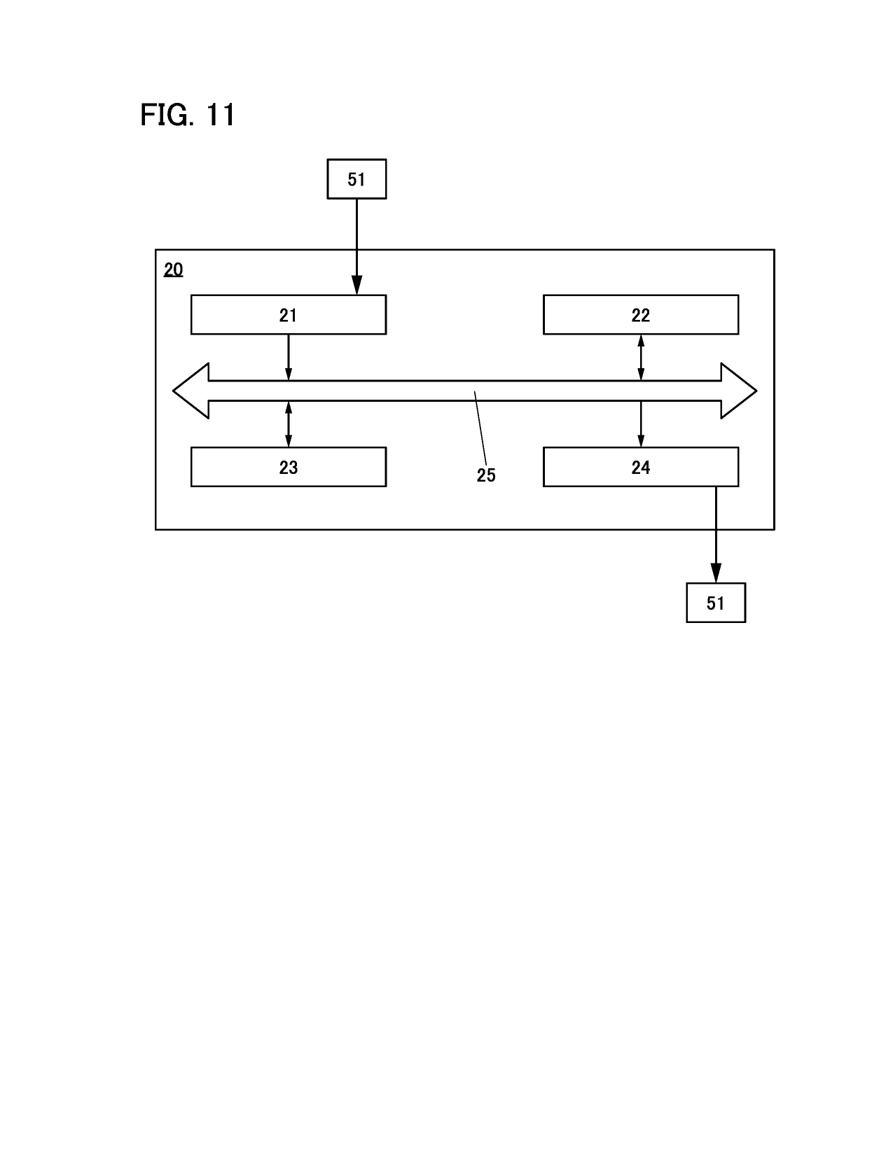

FIG. 11 is a block diagram illustrating a structure of an information processing device that can be used for the information processing system of one embodiment of the present invention.

### Structure example 1 of information processing system

The information processing system described in this embodiment includes a component 110, a component 130, and a component 120 (see FIG. 1).

An information processing device having a function of the component 110, an information processing device having a function of the component 130, and an information processing device having a function of the component 120 each include an arithmetic device and a communication device, for example. The communication devices can be connected to each other via a network 51, for example, to construct the information processing system of one embodiment of the present invention.

### Example 1 of component 110

The component 110 has a function of receiving information Inf and transmitting it to the component 120, and a function of receiving a suggestion Rec1 and providing it to a user 99 of the information processing system, for example. Specifically, using an output device such as a display device, a speaker, a printer, or a memory device, the suggestion Rec1 is provided for the user 99 of the information processing system.

Note that the information Inf includes a condition Cond and information specifying a substance Matl (see FIG. 3A). For example, the information Inf can include a reaction temperature, a reaction time, pressure, and the like which the user 99 of the information processing system prefers in synthesis of the substance Matl in addition to the chemical structural formula of the substance Matl.

For example, the user 99 of the information processing system inputs the information Inf to the component 110. Specifically, the user 99 of the information processing system inputs the information Inf to the component 110 with the use of an input device such as a keyboard, a mouse, an eye-gaze input device, or a microphone.

### Example 1 of component 130

The component 130 has a function of receiving a prompt Pt1(x), a function of transmitting an evaluation result ER(x) to the component 120, and a function of performing processing with use of a large language model LLM.

### Example 1 of large language model LLM

The large language model LLM has a function of generating the evaluation result ER(x) in accordance with the prompt Pt1(x).

### Example 1 of component 120

The component 120 has a function of receiving the information Inf and sharing it in the component 120, a function of transmitting the prompt Pt1(x) to the component 130, and a function of receiving the evaluation result ER(x) and transmitting the suggestion Rec1 to the component 110.

The component 120 includes a subcomponent 120A, a subcomponent 120B, and a subcomponent 120C (see FIG. 2).

### Example 1 of subcomponent 120A

The subcomponent 120A has a function of performing processing using a database DB and a management system DBMS.

The management system DBMS has a function of creating a list Lst1 from the database DB on the basis of a query Qu1. Note that the list Lst1 includes information on synthesis route information SRI(x) of the substance Matl (see FIG. 4A).

### Synthesis route information SRI(x)

The synthesis route information SRI(x) of the substance Matl includes a starting substance SM and the substance Matl (see FIG. 4B).

The synthesis route information SRI(x) can include an intermediate Int(x,1), an intermediate Int(x,2), and an intermediate Int(x,n-1). Note that n is an integer larger than 1.

The synthesis route information SRI(x) can include conditions for synthesizing the substance Matl from the intermediate Int(x,1), conditions for synthesizing the intermediate Int(x,1) from the intermediate Int(x,2), conditions for synthesizing the intermediate Int(x,n-1) from the starting substance SM, and the like.

### Example 1 of subcomponent 120B

The subcomponent 120B has a function of creating the query Qu1 and a group of prompts Pt1 (see FIG. 2).

### Query Qu1

The query Qu1 includes a query related to the synthesis route and the synthesis conditions of the substance Matl (see FIG. 6A).

### Group of prompts Pt1

The group of prompts Pt1 includes the prompt Pt1(x) (see FIG. 6B). Note that when the list Lst1 includes a plurality of synthesis routes, the subcomponent 120B creates a prompt for each of the synthesis routes. In other words, the group of prompts Pt1 includes prompts created for the respective synthesis routes.

The prompt Pt1(x) includes an instruction g1(), a piece of the synthesis route information SRI(x) selected from the list Lst1, and the information Inf. Note that the instruction g1() includes an instruction to evaluate the synthesis route information SRI(x) on the basis of the condition Cond and generate the evaluation result ER(x).

For example, text in the next paragraph can be used as the prompt Pt1(x).

"Synthesis Route: Synthesis route information SRI(x)

Information: information Inf

Evaluate whether the synthesis route satisfies the conditions shown in the information Inf. Answer "the condition is satisfied" or "the condition is not satisfied" for each of the conditions. Indicate "there is a favorable condition" when there is a favorable condition for the synthesis in addition to the conditions shown in the information Inf. Conversely, indicate "there is unfavorable condition" when there is an unfavorable condition for synthesis."

### Subcomponent 120C

The subcomponent 120C has a function of creating the suggestion Rec1 (see FIG. 2). Note that the suggestion Rec1 includes the synthesis route information SRI(x) and the evaluation result ER(x).

### Evaluation result ER(x)

The evaluation result ER(x) includes an evaluation score Sco(x) (see FIG. 3B). Note that the evaluation score Sco(x) increases as the difference between the condition Cond and the synthesis route information SRI(x) becomes small. The suggestion Rec1 includes the evaluation result ER(x) in descending order of the evaluation score Sco(x). For example, the subcomponent 120C can use the number of "there is a favorable condition" and the number of "there is an unfavorable condition" included in the evaluation result ER(x) as the evaluation score Sco(x).

Accordingly, the synthesis route of the substance Matl can be searched using the database DB. The one or more synthesis routes can be searched using the database DB. In addition, a difference between the condition Cond and the synthesis conditions obtained from the database DB can be found. Furthermore, the suggestion Rec1 can be provided in ascending order of the difference between the condition Cond and the synthesis conditions obtained from the database DB. As a result, a novel information processing system that is highly convenient, useful, or reliable can be provided.

### Example 2 of subcomponent 120A

The subcomponent 120A has a function of performing processing using a graph database GDB. Note that the synthesis route information SRI(x) is stored in the graph database GDB.

### EXAMPLE OF GRAPH DATABASE GDB

The graph database GDB includes a node Nd_0, a node Nd(x,1), and an edge Edg(x,1) (see FIG. 5A). The graph database GDB includes a node Nd(x,2), an edge Edg(x,2), a node Nd(x,n-1), a node Nd(x,n), and an edge Edg(x,n).

Note that the graph database GDB can also store synthesis route information different from the synthesis route information SRI(x). For example, a synthesis route from a starting substance SM2 to the substance Matl through an intermediate Int21 and an intermediate Int22 can be stored.

The edge Edg(x,1) connects the node Nd_0 and the node Nd(x,1), the edge Edg(x,2) connects the node Nd(x,1) and the node Nd(x,2), and the edge Edg(x,n) connects the node Nd(x,n-1) and the node Nd(x,n). Note that the edge Edg(x,1) includes a condition for moving from the node Nd(x,1) to the node Nd_0.

In particular, the synthesis route information SRI(x) includes three or more nodes.

For example, the network of organic chemistry, NOC, can be used for the database DB.

### Example of synthesis route information SRI(x)

The synthesis route information SRI(x) includes the node Nd_0 and an edge list EL(x). Note that the node Nd_0 is assigned to the substance Matl, and the edge Edg(x,1) is assigned to a generation reaction of the substance Matl.

The node Nd(x,1) is assigned to the intermediate Int(x,1), the edge Edg(x,2) is assigned to a generation reaction of the intermediate Int(x,1), and the node Nd(x,2) is assigned to the intermediate Int(x,2). The node Nd(x,n-1) is assigned to the intermediate Int(x,n-1), the edge Edg(x,n) is assigned to a generation reaction of the intermediate Int(x,n-1), and the node Nd(x,n) is assigned to the starting substance SM.

For example, the conditions for synthesizing the substance Matl from the intermediate Int(x,1) can be stored in the edge Edg(x,1), and the conditions for synthesizing the intermediate Int(x,1) from the intermediate Int(x,2) can be stored in the edge Edg(x,2). The conditions for synthesizing the intermediate Int(x,n-1) from the starting substance SM can be stored in the edge Edg(x,n).

### Example of edge list EL(x)

The edge list EL(x) includes the edge Edg(x,1) (see FIG. 5B). The edge list EL(x) includes the edge Edg(x,2) and the edge Edg(x,n).

Accordingly, the synthesis route of the substance Matl can be searched using the database DB. The one or more synthesis routes can be searched using the database DB. In addition, a difference between the condition Cond and the synthesis conditions obtained from the database DB can be found. As a result, a novel information processing system that is highly convenient, useful, or reliable can be provided.

### Example 2 of component 110

The component 110 has a function of receiving the synthesis route information SRI(x) and transmitting it to the component 120, and a function of receiving a procedure manual PM and providing it to the user 99 of the information processing system, for example (see FIG. 7). Specifically, with use of an output device such as a display device, a speaker, a printer, or a memory device, the procedure manual PM is provided for the user 99 of the information processing system.

The synthesis route information SRI(x) is selected from the suggestion Rec1. For example, when the suggestion Rec1 includes a plurality of pieces of synthesis route information, the user 99 of the information processing system can select a synthesis route closest to desired synthesis conditions (e.g., reaction temperature, reaction time, and pressure) from the suggestion Rec1 and can use the synthesis route for the synthesis route information SRI(x).

The synthesis route information SRI(x) includes the edge list EL(x), and the edge list EL(x) includes the edge Edg(x,1). Note that the edge Edg(x,1) includes information specifying a document Doc(x,1) (see FIG. 9B). The edge list EL(x) can include the edge Edg(x,2) to the edge Edg(x,n). The edge Edg(x,2) includes information specifying a document Doc(x,2), and the edge Edg(x,n) includes information specifying a document Doc(x,n).

For example, the user 99 of the information processing system inputs the synthesis route information SRI(x) to the component 110. Specifically, the user 99 of the information processing system inputs the synthesis route information SRI(x) to the component 110 with the use of an input device such as a keyboard, a mouse, or an eye-gaze input device.

### Example 2 of component 130

The component 130 has a function of receiving a prompt Pt2, a function of transmitting the procedure manual PM to the component 120, and a function of performing processing with use of the large language model LLM.

### Example 2 of large language model LLM

The large language model LLM has a function of generating the procedure manual PM in accordance with the prompt Pt2.

### Example 2 of component 120

The component 120 has a function of receiving the synthesis route information SRI(x) and sharing it in the component 120, a function of transmitting the prompt Pt2 to the component 130, and a function of receiving the procedure manual PM and transmitting it to the component 110.

### Example 3 of subcomponent 120A

The subcomponent 120A has a function of creating a list Lst2 from the graph database GDB using the management system DBMS on the basis of a query Qu2 (see FIG. 8). Note that the list Lst2 stores the document Doc(x,1).

### Example 2 of subcomponent 120B

The subcomponent 120B has a function of creating the query Qu2 and the prompt Pt2.

### Query Qu2

The query Qu2 includes a query for collecting documents specified in the edge list EL(x) into the list Lst2 (see FIG. 9A and FIG. 10B). For example, the list Lst2 stores documents in accordance with the order described in the synthesis route information SRI(x).

### Prompt Pt2

The prompt Pt2 includes an instruction g2() and the list Lst2 (see FIG. 10A). Note that the instruction g2() includes an instruction to generate the procedure manual PM from the list Lst2.

For example, text in the next paragraph can be used as the prompt Pt2.

"Synthesis Route: List Lst2

Document: List Lst2

Create a synthesis procedure manual of the synthesis routes that are represented in the order stored in the list with reference to the document."

Thus, for example, the user of the information processing system can select the synthesis route information SRI(x) from the suggestion Rec1. The information processing system of one embodiment of the present invention can collect the document related to the selected synthesis route information SRI(x) from the graph database GDB. The information processing system of one embodiment of the present invention can generate and provide the procedure manual PM from the document related to the synthesis route information SRI(x). As a result, a novel information processing system that is highly convenient, useful, or reliable can be provided.

### Structure example 2 of information processing system

Another information processing system described in this embodiment includes the component 110, the component 120, and the component 130 (see FIG. 1).

The information processing system of one embodiment of the present invention can be composed of an information processing device having a function of the component 110, an information processing device having a function of the component 120, and an information processing device having a function of the component 130, for example. Note that the number of information processing devices constituting the information processing system of one embodiment of the present invention is one or more. For example, a plurality of information processing devices can be connected to each other using the network 51 to construct the information processing system of one embodiment of the present invention.

When the information processing system of one embodiment of the present invention is composed of the plurality of information processing devices, loads of data processing can be dispersed.

### Structure example 1 of information processing device

The information processing device with a structure example 1 described in this embodiment can be used as the component 110. The information processing device with the structure example 1 can be referred to as a client computer or the like. For example, a desktop computer can be used as the component 110.

The information processing device with the structure example 1 can receive data input by the user of the information processing system of one embodiment of the present invention. The information processing device with the structure example 1 can provide data output from the information processing system of one embodiment of the present invention to the user.

For example, dedicated application software or a web browser operates in the component 110. Via either of them, the user of the information processing system of one embodiment of the present invention can access the information processing system. Thus, the user can receive service using the information processing system of one embodiment of the present invention.

### Structure example 2 of information processing device

The information processing device with a structure example 2 described in this embodiment can be used as the component 120. For example, a workstation, a server computer, or a supercomputer can be used as the component 120.

The information processing device with the structure example 2 preferably has a function of a parallel computer. When the information processing device with this structure is used as a parallel computer, large-scale computation necessary for artificial intelligence (AI) learning and inference can be performed, for example.

Furthermore, the information processing device with the structure example 2 can perform processing using a natural language model with the use of AI.

For example, it is preferable that the information processing device be capable of performing processing using a natural language model such as GPT-3 (registered trademark), GPT-3.5, GPT-4 (registered trademark), LaMDA, Llama2, or Llama3.

### Structure example 3 of information processing device

The information processing device with a structure example 3 described in this embodiment can be used as the component 130, for example. Note that the component 130 has a larger scale and higher computational capability than the component 120. For example, a large computer such as a server computer or a supercomputer can be used as the component 130.

The information processing device with the structure example 3 preferably has a function of a parallel computer. When the information processing device with this structure is used as a parallel computer, large-scale computation necessary for AI learning and inference can be performed, for example.

Furthermore, the information processing device with the structure example 3 can perform processing using a natural language model with the use of AI. In particular, it is possible to perform processing using a general-purpose language model capable of performing a variety of natural language processing tasks.

For example, processing using a natural language model such as GPT-3 (registered trademark), GPT-3.5, GPT-4 (registered trademark), LaMDA, Llama2, or Llama3 can be performed. In particular, it is preferable that processing using GPT-4 (registered trademark) be available. For example, processing using a language model that is larger in scale than a conventional natural language model can achieve more natural text generation, interaction, or the like.

Note that a service provider using the information processing system of one embodiment of the present invention does not necessarily have its own information processing device with the structure example 3. For example, a service provider can utilize part of the service that another company or the like provides using the information processing device with the structure example 3.

### Structure example of network 51

The network 51 that can be used for the information processing system of one embodiment of the present invention can connect the plurality of information processing devices to each other. Thus, the plurality of information processing devices connected to each other can transmit and receive data to and from each other. Furthermore, loads of the data processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the information processing system of one embodiment of the present invention can provide service using an information processing method of one embodiment of the present invention via the network 51, for example.

In the case where the information processing system of one embodiment of the present invention is constructed in a local network, the possibility of leakage of confidential information can be lower than that in the case of using the Internet, for example.

Structure example 4 of information processing device

An information processing device 20 that can be used for the information processing system of one embodiment of the present invention includes, for example, an input unit 21, a storage unit 22, a processing unit 23, an output unit 24, and a transmission path 25 (see FIG. 11).

Although a block diagram in which components are classified by their functions and shown as independent blocks is shown in the drawing attached to this specification, it is difficult to completely separate actual components according to their functions and one component can relate to a plurality of functions. For example, part of the processing unit 23 functions as the input unit 21 in some cases. In addition, one function can relate to a plurality of components. For example, processing performed in the processing unit 23 is sometimes executed by a different information processing device depending on the processing.

### Input unit 21

The input unit 21 can receive data from the outside of the information processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### Storage unit 22

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The information processing device can include a database in addition to the storage unit 22. The information processing device can have a function of extracting data from a database outside the storage unit 22, the information processing device, or the information processing system. Alternatively, the information processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for "nonvolatile oxide semiconductor random access memory (RAM)". The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by utilizing characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for "dynamic oxide semiconductor RAM" and refers to a RAM including a one-transistor (1T) and one-capacitor (1C) memory cell. The DOSRAM is a DRAM formed using an OS transistor and temporarily stores data sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or indium gallium zinc oxide (In–Ga–Zn oxide, also referred to as "IGZO") can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium but contains any of zinc, gallium, and tin (e.g., zinc tin oxide and gallium tin oxide).

### Processing unit 23

The processing unit 23 has a function of performing processing such as arithmetic operation, analysis, and inference with the use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the storage unit 22 and a memory region of the processor.

The processing unit 23 can include a main memory. The main memory includes at least one of a volatile memory such as RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor containing silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When at least one of a register and a cache memory included in the processing unit has such a feature, the processing unit can be operated only when needed, and otherwise can be off while data processed immediately before turning off the processing unit is stored in the memory element. In other words, normally-off computing is possible and the power consumption of the information processing system can be reduced.

The information processing device preferably uses AI for at least part of its processing.

In particular, the information processing device preferably uses an artificial neural network (ANN, hereinafter also simply referred to as a neural network). The neural network is constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as "learning" in some cases.

In this specification and the like, drawing a new conclusion from a neural network formed with the connection strength obtained by learning is referred to as "inference" in some cases.

### Output unit 24

The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as the input unit 21 and the output unit 24.

### <<Transmission path 25>>

The transmission path 25 has a function of transmitting data. Data transmission and reception between the input unit 21, the storage unit 22, the processing unit 23, and the output unit 24 can be performed via the transmission path 25. Specifically, an external bus, a LAN or the Internet can be used for the transmission path 25.

Note that this embodiment can be combined with any of the other embodiments in this specification as appropriate.

### Embodiment 2

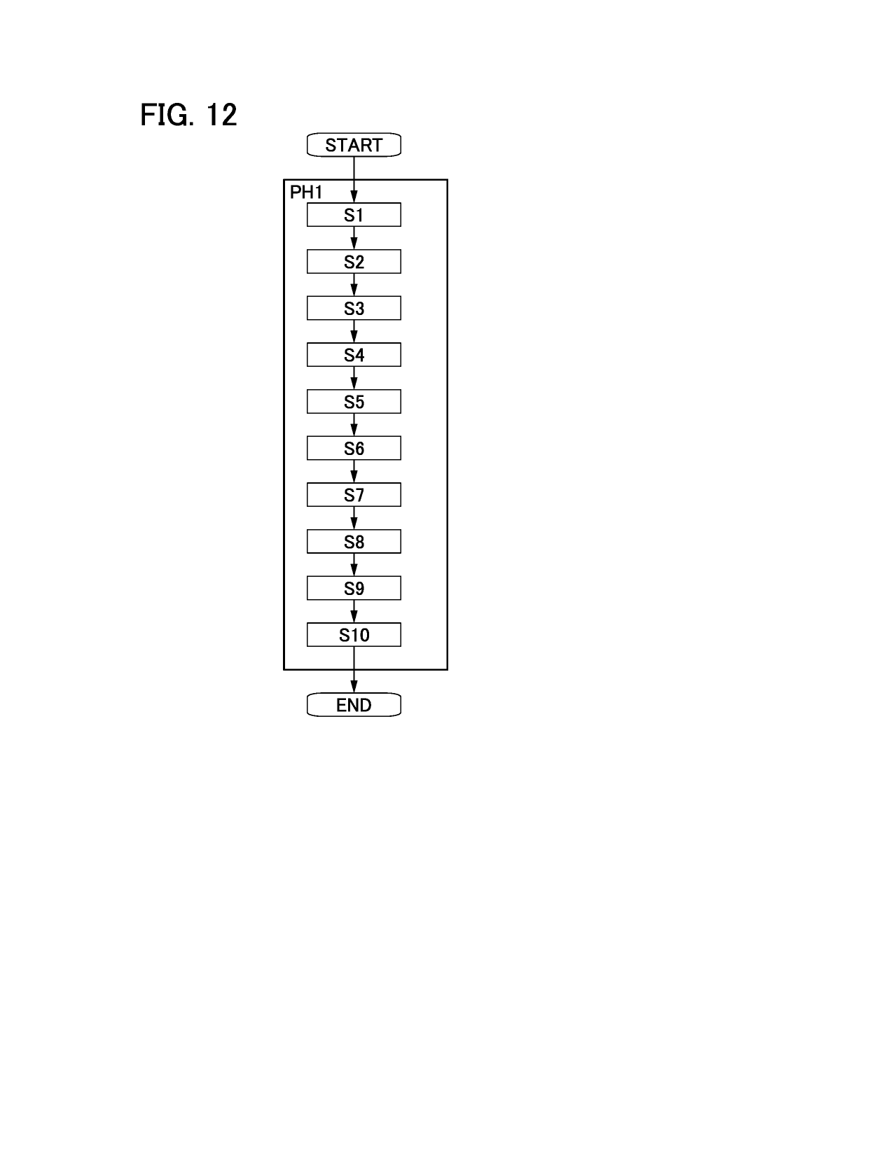

In this embodiment, an information processing method of one embodiment of the present invention will be described with reference to FIG. 12 to FIG. 15.

FIG. 12 is a flowchart showing an information processing method of one embodiment of the present invention.

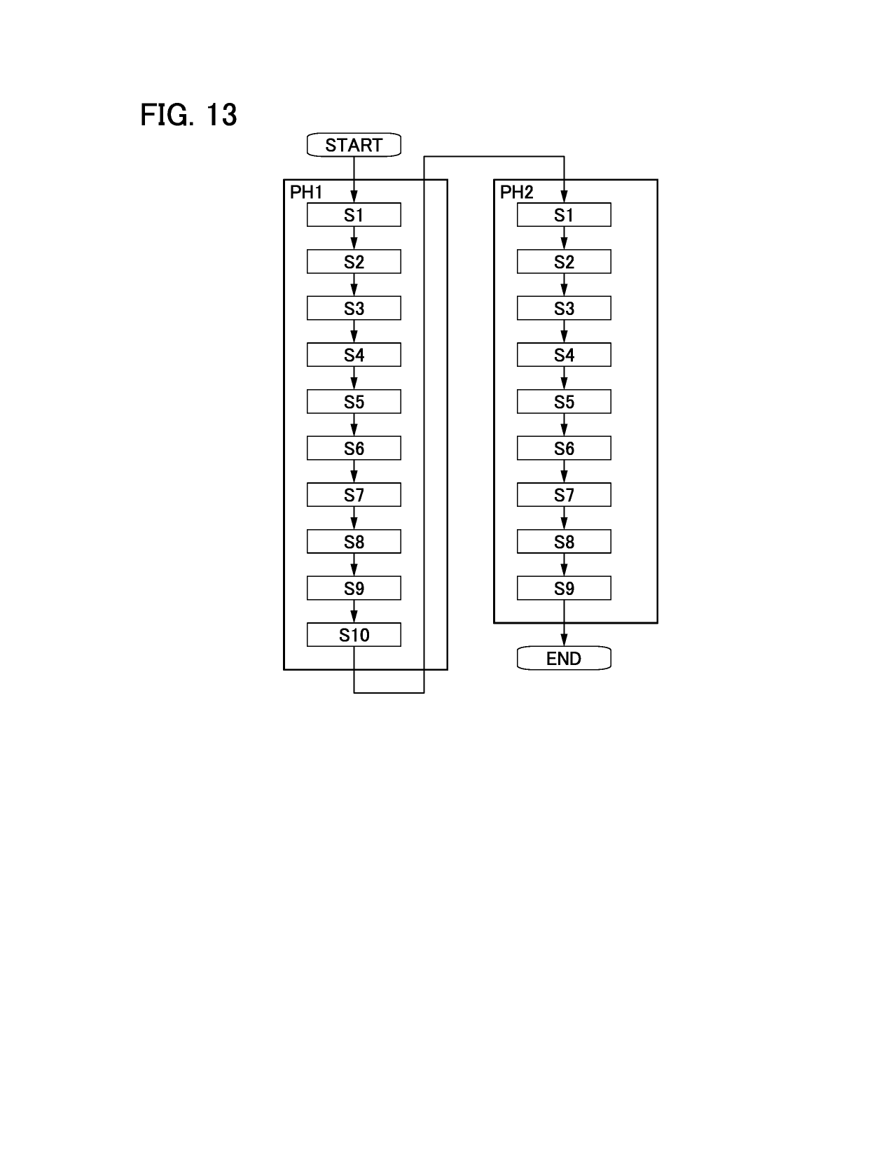

FIG. 13 is a flowchart showing an information processing method of one embodiment of the present invention.

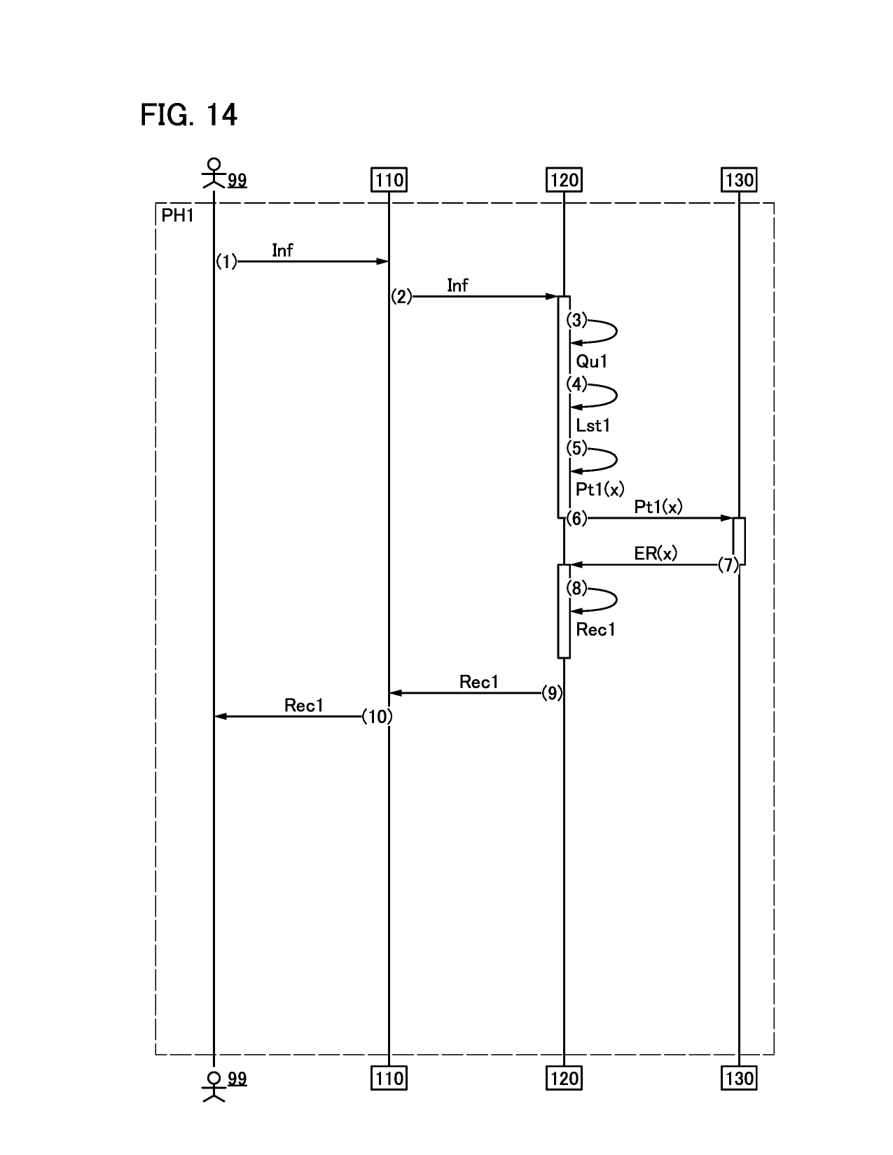

FIG. 14 is a sequence diagram showing an information processing method of one embodiment of the present invention.

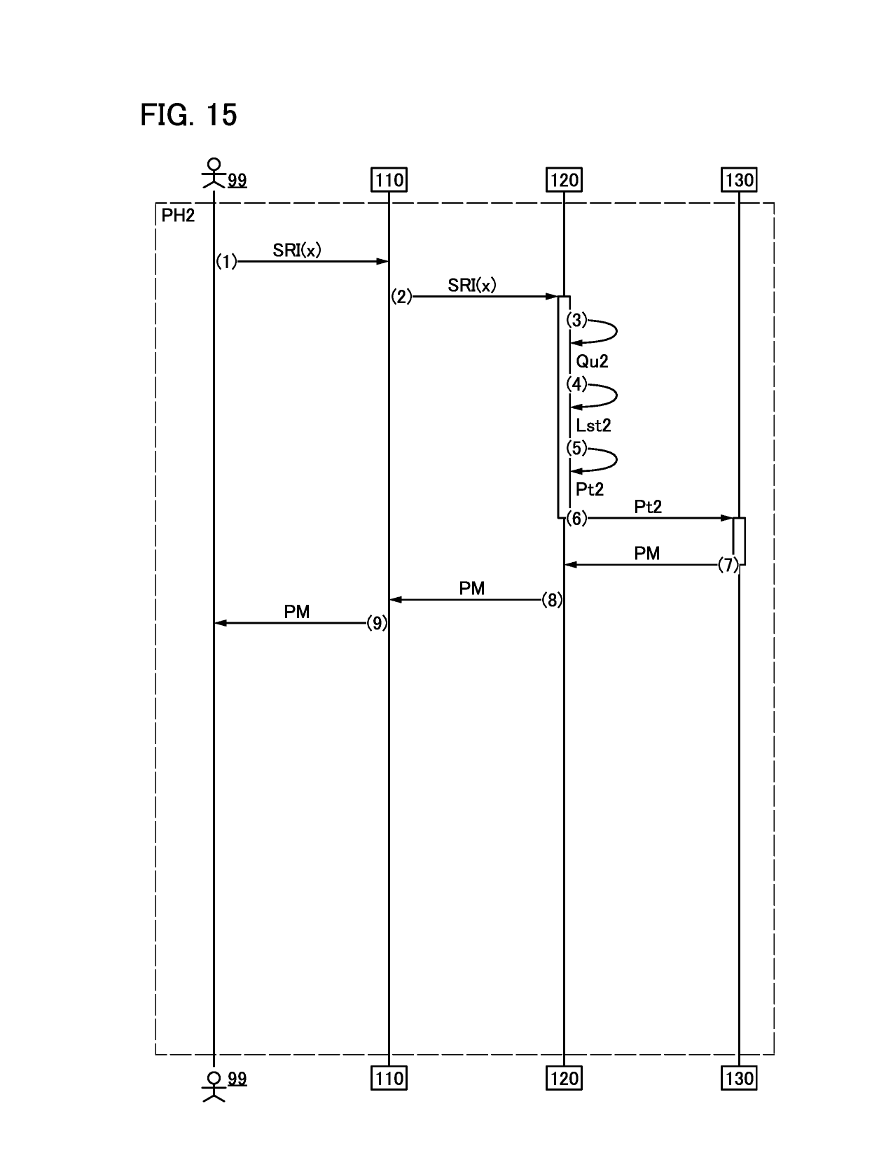

FIG. 15 is a sequence diagram showing an information processing method of one embodiment of the present invention.

### Example 1 of information processing method

The information processing method of one embodiment of the present invention includes Phase PH1 (see FIG. 12).

### Example of Phase PH1

Phase PH1 includes Step S1 to Step S10.

Step S1

In Step S1 of Phase PH1, the component 110 receives the information Inf and transmits it to the component 120. Note that the information Inf includes the condition Cond and information specifying the substance Matl. For example, the user 99 of the information processing system inputs the information Inf. Step S1 corresponds to an arrow extending from (1) and an arrow extending from (2) in FIG. 14.

Step S2

In Step S2 of Phase PH1, the component 120 receives the information Inf and shares it in the component 120.

The component 120 includes the subcomponent 120A, the subcomponent 120B, and the subcomponent 120C. The subcomponent 120A has a function of performing processing using the database DB and the management system DBMS.

Step S3

In Step S3 of Phase PH1, the subcomponent 120B creates the query Qu1 and shares it in the component 120. Note that the query Qu1 includes a query for the synthesis route and the synthesis conditions of the substance Matl. Step S3 corresponds to an arrow extending from (3) in FIG. 14.

Step S4

In Step S4 of Phase PH1, the subcomponent 120A creates the list Lst1 from the database DB using the management system DBMS on the basis of the query Qu1 and shares the list Lst1 in the component 120. Note that the list Lst1 includes information on the synthesis route information SRI(x) of the substance Matl. Step S4 corresponds to an arrow extending from (4) in FIG. 14.

Step S5

In Step S5 of Phase PH1, the subcomponent 120B creates the group of prompts Pt1 and transmit prompt Pt1(x) to the component 130. Note that the group of prompts Pt1 includes the prompt Pt1(x).

The prompt Pt1(x) includes the instruction g1(), a piece of the synthesis route information SRI(x) selected from the list Lst1, and the information Inf. The instruction g1() includes an instruction to evaluate the synthesis route information SRI(x) on the basis of the condition Cond and generate the evaluation result ER(x). Step S5 corresponds to an arrow extending from (5) and an arrow extending from (6) in FIG. 14.

Step S6

In Step S6 of Phase PH1, the component 130 receives the prompt Pt1(x) and generates the evaluation result ER(x) with use of the large language model LLM.

Step S7

In Step S7 of Phase PH1, the component 130 transmits the evaluation result ER(x) to the component 120. Step S7 corresponds to an arrow extending from (7) in FIG. 14.

Step S8

In Step S8 of Phase PH1, the component 120 receives the evaluation result ER(x) and shares it in the component 120.

Step S9

In Step S9 of Phase PH1, the subcomponent 120C creates the suggestion Rec1 and transmit it to the component 110. Note that the suggestion Rec1 includes the synthesis route information SRI(x) and the evaluation result ER(x). Step S9 corresponds to an arrow extending from (8) in FIG. 14.

Step S10

In Step S10 of Phase PH1, the component 110 receives the suggestion Rec1 and provides it to the user 99 of the information processing system, for example. Step S10 corresponds to an arrow extending from (9) and an arrow extending from (10) in FIG. 14.

Accordingly, the synthesis route of the substance Matl can be searched using the database DB. The one or more synthesis routes can be searched using the database DB. In addition, a difference between the condition Cond and the synthesis conditions obtained from the database DB can be found. As a result, a novel information processing method that is highly convenient, useful, or reliable can be provided.

### Example 2 of information processing method

The information processing method of one embodiment of the present invention is an information processing method including Phase PH1 and Phase PH2 (see FIG. 13).

### Example of Phase PH2

Phase PH1 follows Phase PH2, and Phase PH2 includes Step S1 to Step S9.

Step S1

In Step S1 of Phase PH2, the component 110 receives the synthesis route information SRI(x) and transmits it to the component 120. For example, the user 99 of the information processing system inputs the synthesis route information SRI(x). Step S1 corresponds to an arrow extending from (1) and an arrow extending from (2) in FIG. 15.

Step S2

In Step S2 of Phase PH2, the component 120 receives the synthesis route information SRI(x) and shares it in the component 120.

Step S3

In Step S3 of Phase PH2, the subcomponent 120B creates the query Qu2 and shares it in the component 120.

Note that the query Qu2 includes a query for collecting documents specified in the edge list EL(x) into the list Lst2. The edge list EL(x) includes the edge Edg(x,1), and the edge Edg(x,1) includes information specifying the document Doc(x,1). The list Lst2 stores the document Doc(x,1). Step S3 corresponds to an arrow extending from (3) in FIG. 15.

Step S4

In Step S4 of Phase PH2, the subcomponent 120A creates the list Lst2 from the database DB on the basis of the query Qu2 with the use of the management system DBMS and shares the list Lst2 in the component 120. Step S4 corresponds to an arrow extending from (4) in FIG. 15.

Step S5

In Step S5 of Phase PH2, the subcomponent 120B creates the prompt Pt2 and transmits it to the component 130. Note that the prompt Pt2 includes the instruction g2() and the list Lst2, and the instruction g2() includes an instruction to generate the procedure manual PM from the list Lst2. Step S5 corresponds to an arrow extending from (5) and an arrow extending from (6) in FIG. 15.

Step S6

In Step S6 of Phase PH2, the component 130 receives the prompt Pt2 and generates the procedure manual PM with the use of the large language model LLM.

Step S7

In Step S7 of Phase PH2, the component 130 transmits the procedure manual PM to the component 120. Step S7 corresponds to an arrow extending from (7) in FIG. 15.

Step S8

In Step S8 of Phase PH2, the component 120 receives the procedure manual PM and transmits it to the component 110. Step S8 corresponds to an arrow extending from (8) in FIG. 15.

Step S9

In Step S9 of Phase PH2, the component 110 receives the procedure manual PM and provides it to the user 99 of the information processing system, for example. Step S9 corresponds to an arrow extending from (9) in FIG. 15.

Thus, for example, the user of the information processing system can select the synthesis route information SRI(x) from the suggestion Rec1. The information processing system of one embodiment of the present invention can collect the document related to the selected synthesis route information SRI(x) from the edge list EL(x). The information processing system of one embodiment of the present invention can generate and provide the procedure manual PM from the document related to the synthesis route information SRI(x). As a result, a novel information processing method that is highly convenient, useful, or reliable can be provided.

Note that this embodiment can be combined with any of the other embodiments in this specification as appropriate.

This application is based on Japanese Patent Application Serial No. 2024-190541 filed with Japan Patent Office on October 30, 2024, the entire contents of which are hereby incorporated by reference.

What is claimed is:

1. An information processing system comprising:
a first component;
a second component; and
a third component comprising a first subcomponent configured to perform processing using a database and a management system, a second subcomponent configured to create a first query and a group of prompts including a first prompt, and a third subcomponent configured to create a suggestion,
wherein the third component is configured to transmit the suggestion to the first component,
wherein the first component is configured to receive first information and transmit the first information to the third component,
wherein the first information comprises a condition and information specifying a substance,
wherein the third component is configured to transmit the first prompt to the second component,
wherein the second component is configured to perform processing using a large language model in order to generate an evaluation result in accordance with the first prompt and to transmit the evaluation result to the third component,
wherein the management system is configured to create a first list from the database on the basis of the first query,
wherein the first list comprises information on a synthesis route information of the substance,
wherein the first query comprises a query for a synthesis route and a synthesis condition of the substance,
wherein the first prompt comprises a first instruction, a piece of the synthesis route information selected from the first list, and the first information,
wherein the first instruction comprises an instruction to evaluate the synthesis route information on the basis of the condition to generate the evaluation result, and
wherein the suggestion comprises the synthesis route information and the evaluation result.

2. An information processing system comprising:
a first component;
a second component; and
a third component comprising a first subcomponent configured to perform processing using a management system and a graph database comprising a first node, a second node, and an edge connecting the first node and the second node, a second subcomponent configured to create a first query and a group of prompts including a first prompt, and a third subcomponent configured to create a suggestion,
wherein the third component is configured to transmit the suggestion to the first component,
wherein the first component is configured to receive first information and transmit the first information to the third component,
wherein the first information comprises a condition and information specifying a substance,
wherein the third component is configured to transmit the first prompt to the second component,
wherein the second component is configured to perform processing using a large language model in order to generate an evaluation result in accordance with the first prompt and to transmit the evaluation result to the third component,
wherein the management system is configured to create a first list from the graph database on the basis of the first query,
wherein the first list comprises information on a synthesis route information of the substance,
wherein the first query comprises a query for a synthesis route and a synthesis condition of the substance,
wherein the first prompt comprises a first instruction, a piece of the synthesis route information selected from the first list, and the first information,
wherein the first instruction comprises an instruction to evaluate the synthesis route information on the basis of the condition to generate the evaluation result,
wherein the suggestion comprises the synthesis route information and the evaluation result,
wherein the edge comprises a condition for moving from the second node to the first node,
wherein the synthesis route information comprises the first node and an edge list comprising the edge,
wherein the first node is assigned to the substance, and
wherein the edge is assigned to a generation reaction of the substance.

3. The information processing system according to claim 2,
wherein the synthesis route information comprises three or more nodes.

4. The information processing system according to claim 1,
wherein the database comprises the network of organic chemistry.

5. The information processing system according to claim 1,
wherein the second component is configured to perform processing using the large language model in order to generate a plurality of evaluation results in accordance with the first prompt,
wherein each of the plurality of evaluation results comprises an evaluation score,
wherein the evaluation score increases as a difference between the condition and the synthesis route information becomes small, and
wherein the suggestion comprises the plurality of evaluation results in descending order of the evaluation score.

6. The information processing system according to claim 2,
wherein the synthesis route information is selected from the suggestion,
wherein the synthesis route information comprises the edge list,
wherein the edge comprises information specifying a document,
wherein the second subcomponent is configured to create a second query and a second prompt,
wherein the third component is configured to transmit the second prompt to the second component,
wherein the second component is configured to transmit a procedure manual generated by the large language model in accordance with the second prompt to the third component,
wherein the third component is configured to transmit the procedure manual to the first component,
wherein the first subcomponent is configured to create a second list from the graph database using the management system on the basis of the second query,
wherein the second list stores the document,
wherein the second query comprises a second instruction to add the document specified in the edge list to the second list,
wherein the second prompt comprises a third instruction and the second list, and
wherein the third instruction comprises an instruction to generate the procedure manual from the second list.

7. An information processing method comprising a first phase,
wherein the first phase comprises a first step, a second step, a third step, a fourth step, a fifth step, a sixth step, and a seventh step,
wherein in the first step of the first phase, a first component transmits first information to a second component comprising a first subcomponent, a second subcomponent, and a third subcomponent,
wherein the first information comprises a condition and information specifying a substance,
wherein the first subcomponent is configured to perform processing using a database and a management system,
wherein in the second step of the first phase, the second subcomponent creates a first query,
wherein the first query comprises a query related to a synthesis route and a synthesis condition of the substance,
wherein in the third step of the first phase, the first subcomponent creates a first list from the database using the management system on the basis of the first query,
wherein the first list comprises information on a synthesis route information of the substance,
wherein in the fourth step of the first phase, the second subcomponent creates a group of prompts comprising a first prompt and transmits the first prompt to a third component,
wherein the first prompt comprises a first instruction, a piece of the synthesis route information selected from the first list, and the first information,
wherein the first instruction comprises an instruction to evaluate the synthesis route information on the basis of the condition to generate an evaluation result,
wherein in the fifth step of the first phase, the third component generates the evaluation result with use of a large language model in accordance with the first prompt,
wherein in the sixth step of the first phase, the third component transmits the evaluation result to the second component, and
wherein in the seventh step of the first phase, the third subcomponent creates a suggestion comprising the synthesis route information and the evaluation result and transmits the suggestion to the first component.

8. The information processing method according to claim 7, further comprising a second phase,
wherein the second phase starts after the first phase,
wherein the second phase comprises a first step, a second step, a third step, a fourth step, a fifth step, a sixth step, a seventh step, an eighth step, and a ninth step,
wherein in the first step of the second phase, the first component receives the synthesis route information and transmits the synthesis route information to the second component,
wherein in the second step of the second phase, the second component receives the synthesis route information and shares the synthesis route information in the second component,
wherein in the third step of the second phase, the second subcomponent creates a second query and shares the second query in the second component,
wherein the second query comprises a query to collect a document specified in an edge list into a second list,
wherein the edge list comprises an edge,
wherein the edge comprises information specifying the document,
wherein the second list stores the document,
wherein in the fourth step of the second phase, the first subcomponent creates the second list from the database using the management system on the basis of the second query and shares the second list in the second component,
wherein in the fifth step of the second phase, the second subcomponent creates a second prompt and transmits the second prompt to the third component,
wherein the second prompt comprises a second instruction and the second list,
wherein the second instruction comprises an instruction to generate a procedure manual from the second list,
wherein in the sixth step of the second phase, the third component receives the second prompt and generates the procedure manual with use of the large language model,
wherein in the seventh step of the second phase, the third component transmits the procedure manual to the second component,
wherein in the eighth step of the second phase, the second component receives the procedure manual and transmits the procedure manual to the first component, and
wherein in the ninth step of the second phase, the first component receives the procedure manual and provides the procedure manual.
